(19) United States
(12) Patent Application Publication
(10) Pub. No.: US 2007/0249397 A1
(43) Pub. Date: Oct. 25, 2007

(54) Modular input device and portable handset and remote control provided with the same

(75) Inventors: Min Woong Choi, Gyunggi-do (KR); Ho Chul Joung, Gyunggi-do (KR); Gi Lyong Na, Gyunggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/700,779

(22) Filed: Feb. 1, 2007

(30) Foreign Application Priority Data
Apr. 20, 2006 (KR) 10-2006-0035826

(51) Int. Cl. H04M 1/00

(52) U.S. Cl. 455/556.1

(57) ABSTRACT

Disclosed is a modular input device comprising a manipulator movable in random directions, a sensor chip for detecting displacement of the manipulator, an elastic member for returning the displaced manipulator to its originally set position, a direction manipulator operating independently from the manipulator for providing manipulation space for the manipulator and for manipulating directions, a magnetic body moving in association with the manipulator for informing the sensor chip of the displacement of the manipulator, a circuit board having an operation switch at a position corresponding to the manipulator for outputting a signal detected by the sensor chip to an external device, and a housing for enclosing the manipulator, the sensor chip, the magnetic body and the circuit board.

### CROSS REFERENCE TO RELATED APPLICATION(S)

This application claims the benefit of Korean Patent Application No. 10-2006-0035826, filed on Apr. 20, 2006, entitled “Modular Input Unit and Portable Handset and Remote controller Provided with the Same”, which is hereby incorporated by reference in its entirety into this application.

### BACKGROUND OF THE INVENTION

1. Field of the Invention

The present invention relates to a modular input device and a portable handset, and more particularly, to a small-sized modular input device and a portable handset provided with the same.

2. Description of the Related Art

An input device is an interface unit installed in a variety of handsets, such as mobile telephones or remote controls generally used in households, in order to deliver input signals from a user to the handset. The input device has evolved so as to have a small size and to be easy for a user to manipulate.

With reference to FIG. 9 and FIG. 10, a conventional portable handset with an input device disclosed in Japanese Laid-Open Patent Publication No. 2003-50666, entitled “Input Device and Portable Handset Provided with the same,” is illustrated.

As shown in FIG. 9, a mobile telecommunication handset according to the conventional art comprises a first box 10A, a second box 10B, and a hinged part 9.

The first box 10A encloses an input device 20 and a microphone 12 therein, and the second box 10B encloses a display unit 11, a speaker 13 and an antenna 14 therein. Further, the first box 10A has a grooved bottom serving as a manipulation area, and the input device 20 has a manipulation part 15 and a manipulation area 16.

FIG. 10 illustrates details of the input device 20 shown in FIG. 9.

The input device 20 comprises a movable body 21, a substrate 23, an elastic body 25, horizontal direction sensors 26 and 26, a vertical direction sensor 28, and a conductor 29. The movable body 21 comprises a horizontally movable part 21a and a vertically movable part 21b.

The movable body 21 is elastically connected to the first box 22 since the horizontally movable part 21 is connected to the first box 22 by the elastic body 25. The elastic body 25 returns the movable body 21, which previously moved against the direction of the elasticity, to its original position.

On a circuit board 24, the substrate 23 having the horizontal sensors 26 and 27 and the vertical sensor 28 thereon is installed. A conductor 29 is provided to the horizontally movable part 21a for each direction to be sensed, and moves on the substrate 23.

If a force is vertically applied to the movable body 21, the flexible part 30 of the movable body 20 bends and the vertically movable part 21b is suspended and moves in the vertical direction. Further, if the vertically movable part 21b is suspended and moves in the vertical direction, the vertically movable part 21a comes into contact with the vertical direction sensor 28. The vertical direction sensor 28 detects the displacement of the vertically movable part 21b by detecting contact between the vertically movable part 21b and the sensor 28. The vertical direction sensor 28 is a metal dome.

The above-described conventional input device has a disadvantage because the circuit board 24 of the input device is the main circuit board installed in a mobile telecommunication handset and is integrated with a key pad. As a consequence thereof, it is impossible to selectively replace only damaged parts from a handset in the case in which some parts in the handset, such as the input device or the key pad, are damaged. That is, the handset including the failed input device or the damaged key pad must be replaced as a whole.

Further, since the input device is installed on the main circuit board, it is difficult for handset manufacturers to obtain discrete input devices through an outsourcing method in the case in which the handset manufacturers want to use discrete input devices manufactured by other component manufacturers in order to install the discrete input device in their handsets.

Still further, since the input device detects the displacement of the movable body 21 by sensing the contact state between the conductor 29 and the sensors 26 and 27, it is impossible to detect displacement occurring before the conductor 29 installed on the movable body 21 comes into contact with the sensors 26 and 27.

### SUMMARY OF THE INVENTION

Therefore, the present invention has been made in view of the above problems, and it is an object of the present invention to provide a modular input device that can be independently and separately manufactured from a handset into a discrete unit so that it alone can be easily replaced when necessary, whereby input devices and portable handsets using the input devices can be manufactured in different production lines.

It is a further object of the present invention to provide a modular input device that can form a signal by precisely and finely detecting even a small amount of displacement of a manipulator via a hall sensor using magnetic force as a positioning sensor.

It is a still further object of the present invention to provide a portable handset with the modular input device.

In accordance with one aspect of the present invention, the above and other objects can be accomplished by the provision of a modular input device comprising a manipulator movable in random directions, a displacement detector for detecting displacement of the manipulator, a signal output unit for outputting a signal detected by the displacement detector to an external device, and a storage unit for storing the manipulator, the displacement detector, and the signal output unit therein.

The displacement detector of the modular input device may estimate the displacement of the manipulator by detecting a change in intensity of magnetic force caused by movement of the manipulator.

The displacement detector may include a plurality of hall sensors responding to magnetic force.

In accordance with a first embodiment of the present invention, there is provided a modular input device comprising a manipulator movable in random directions, a sensor chip for detecting displacement of the manipulator, a magnetic body moving in association with the manipulator for informing the sensor chip of the displacement, a circuit board having an operation switch installed at a position corresponding to the manipulator for outputting a signal from the sensor chip to an external device, and a housing for enclosing the manipulator, the sensor chip, the magnetic body and the circuit board.

The modular input device may further comprise an elastic body for returning the displaced manipulator to its originally set position.

The modular input device may further comprise a cover for covering the housing and establishing a manipulation space for the manipulator.

In accordance with a second embodiment of the present invention, there is provided a modular input device comprising all the elements in the modular input device according to the first embodiment, and further comprising a direction manipulator for providing a manipulation space for the manipulator and manipulation in various directions.

The modular input device may further comprise an elastic body for returning the displaced manipulator to its originally set position.

The direction manipulator of the modular input device may have a plurality of direction keys and the circuit board may have a plurality of direction switches corresponding to respective direction keys.

In the input devices according to all of the embodiments, the sensor chip may have a plurality of hall sensors responding to magnetic force, and the plurality of hall sensors may be arranged at regular intervals and have the same distance from the originally set position of the magnetic body.

The circuit board may have a flexible circuit part extending to the outside thereof, and the flexible circuit part has a contact terminal to be connected to an external device at an end portion thereof.

The elastic body may have a magnetic body mounting part for mounting the magnetic body thereon, and the manipulator may have a groove for receiving the magnetic body mounting part on which the magnetic body is mounted.

The elastic body may be made of rubber having high elasticity.

In accordance with a further aspect of the present invention, there is provided a portable handset in which any of the input devices according to the above-mentioned embodiments is embedded in such a manner that the input device alone can be replaced.

In accordance with a still further aspect of the present invention, there is provided a portable handset to which any of the input devices according to the above-mentioned embodiments can be externally installed to be connected thereto.

### BRIEF DESCRIPTION OF THE DRAWINGS

The above and other objects, features and other advantageous effects of the present invention will be more clearly understood from the following detailed description taken in conjunction with the accompanying drawings, in which:

FIG. 1 is an exploded perspective view illustrating a modular input device according to a first embodiment of the present invention;

FIG. 2 is a schematic sectional view illustrating the input device shown in FIG. 1;

FIG. 3 is a schematic view showing movement of a magnetic body, which is in association with movement of a manipulator,

FIG. 4 is an exploded perspective view illustrating a modular input device according to a second embodiment of the present invention;

FIG. 5 is a sectional view illustrating the input device shown in FIG. 4;

FIG. 6 is a schematic view illustrating a mobile phone provided with the input device shown in FIG. 1 or FIG. 4;

FIG. 7 is a schematic view illustrating a remote control provided with the input device shown in FIG. 1 or FIG. 4;

FIG. 8 is a schematic view illustrating a mobile phone having the input device shown in FIG. 1 or FIG. 4, in which the input device is installed in an external manner,

FIG. 9 is a schematic view illustrating a mobile phone provided with the conventional input device; and

FIG. 10 is a sectional view illustrating the input device shown in FIG. 9.

### DESCRIPTION OF THE PREFERRED EMBODIMENTS

Hereinafter, a modular input device and a portable handset having the modular input device according to embodiments of the present invention will be described with reference to the accompanying drawings.

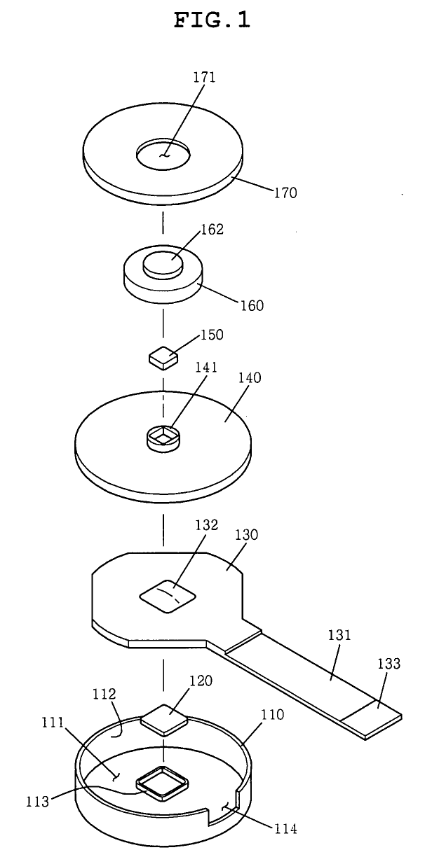

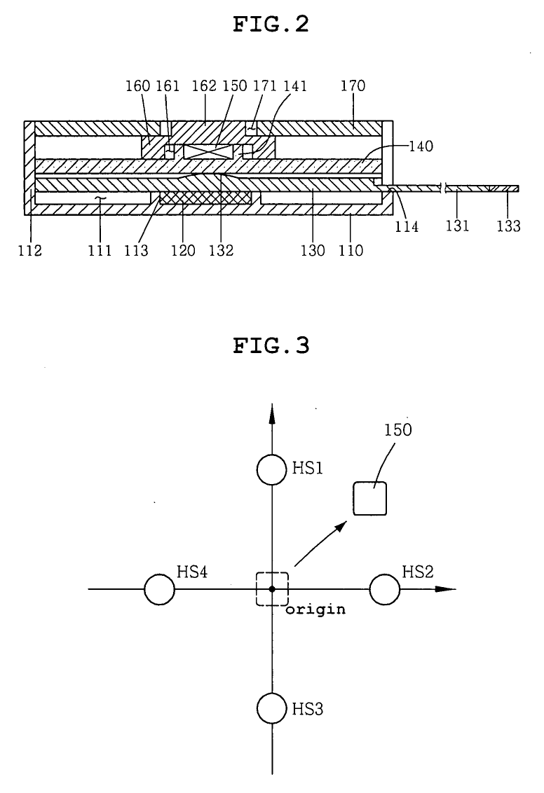

First, a modular input device will be described with reference to FIG. 1 and FIG. 2. FIG. 1 is an exploded perspective view and FIG. 2 is a cross-sectional view illustrating a modular input device according to a first embodiment of the present invention.

As shown in FIG. 1 and FIG. 2, the input device 100 according to the first embodiment of the present invention is implemented as a discrete unit and comprises a housing 110, a sensor chip 120, a circuit board 130, an elastic body 140, a magnetic body 150, a manipulator 160 and a cover 170.

The housing 110 serves to encase all of the other elements of the input device 100, so it forms a bowl shape comprised of a main wall 112 and a space 111. The housing 110 further has a sensor chip mounting part 113 on a central portion thereof in order to receive the sensor chip 120 thereon. The sensor chip mounting part 113 is formed to protrude from the central portion of the housing 110. The main wall 112 has an aperture 114 so that a flexible circuit part 131 connected to the circuit board 130 can be exposed outside so as to be connected to an external device.

The sensor chip 120 is a displacement detecting means for sensing movement of the magnetic body 150 or the manipulator 160, and thus it has a plurality of hall sensors therein in order to sense the movement of the magnetic body 150 or the manipulator 160. According to the first embodiment of the present invention, the sensor chip 120 comprises four hall sensors HS1, HS2, HS3 and HS4 as shown in FIG. 3.

The circuit board 130 is a signal outputting means for outputting a signal inputted using the input device 100 to a portable handset, for example a main circuit board of the portable handset. The circuit board 130 has an operation switch 132, such as a metal dome switch, at a position corresponding to the sensor chip 120. For example, the circuit board 130 has the operation switch 132 installed at the center thereof in the drawings. In the circuit board 130, the flexible circuit part 131 extends to the outside of the circuit board 130, and has a contact terminal 133 at an end portion thereof so as to be connected to an external device.

The elastic body 140 serves to return the manipulator 160 to its originally set position, and is made of a material, such as rubber, having high elasticity. The elastic body 140 can be made of a material other than rubber as long as the material has restoring force. The elastic body 140 has a magnetic body mounting part 141 at a center portion thereof to receive a magnetic body 150 therein. The magnetic body mounting part 141 is installed to protrude from the elastic body 140.

The magnetic body 150 is a manipulation means for delivering movement of the magnetic body 150 or the manipulator 160 to the hall sensors by applying magnetic force to the hall sensors HS1, HS2, HS3 and HS4 (see FIG. 3) embedded in the sensor chip 120, and is received in the magnetic body mounting part 141 provided on the elastic body 140.

The manipulator 160 is a means for allowing a user to input a signal to the input device 100 through manipulation. The manipulator 160 is coated with a material that gives a good tactile sensation. The manipulator 160 has a groove 161 for receiving the magnetic body mounting part 141 on which the magnetic body 150 is mounted therein and a manipulation part 162 is provided at a portion corresponding to the groove 161.

The cover 170 is provided to protect all of the above-described elements from external impact, and is coupled to the inner surface of the housing 110. The cover 170 has an aperture 171 serving as a manipulation space in which the manipulating part 162 of the manipulator 160 is exposed outside and is displaced a certain amount.

In the input device 100, if a user applies force to the manipulating part 162 or to the manipulator 160, the manipulation part 162 or the manipulator 160 is displaced since the magnetic body 150 received in the manipulator 160 moves. The displacement of the magnetic body 150 is delivered to each of the hall sensors provided in the sensor chip 120, so that the movement of the magnetic body 150 or the manipulator 160 is detected.

FIG. 3 schematically illustrates the movement of the magnetic body in association with the movement of the manipulator. In FIG. 3, the magnetic body 150 is moved upward and rightward to a position displaced from the origin shown by the dotted line.

When the magnetic body 150 is located at the origin shown by the dotted line, the same force is applied to the four hall sensors HS1, HS2, HS3 and HS4. However, when the magnetic body 150 is positioned to the upper right of the origin, a relatively large magnetic force is applied to the hall sensors HS1 and HS2, relatively close to the magnetic body 150, but a relatively small magnetic force is applied to the hall sensors HS3 and HS4, relatively far from the magnetic body 150.

As described above, magnetic forces applied to respective hall sensors HS1, HS2, HS3 and HS4 vary according to the displacement of the magnetic body 150, and the hall sensors HS1, HS2, HS3 and HS4 detect the displacement of the magnetic body 150 using the change in intensity of magnetic forces. Due to this, the movement of the manipulating part 162 or the manipulator 160 is detected. As described above, since the displacement of the manipulation part 162 is detected by the change in intensity of magnetic force, micro displacement of the manipulation part 162 can be precisely detected, unlike the conventional art.

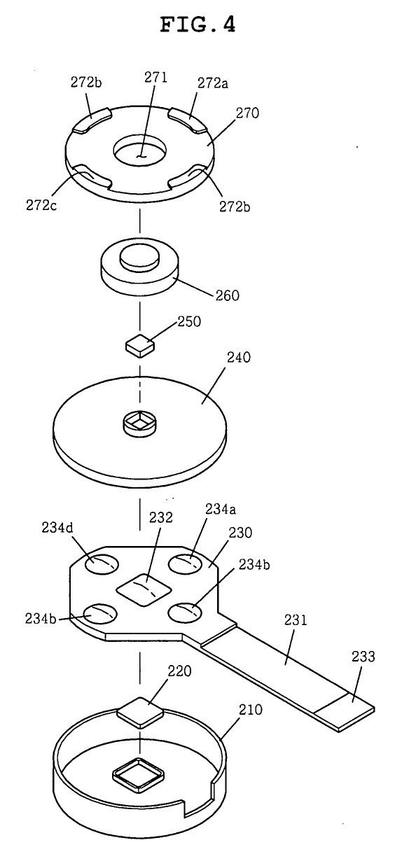

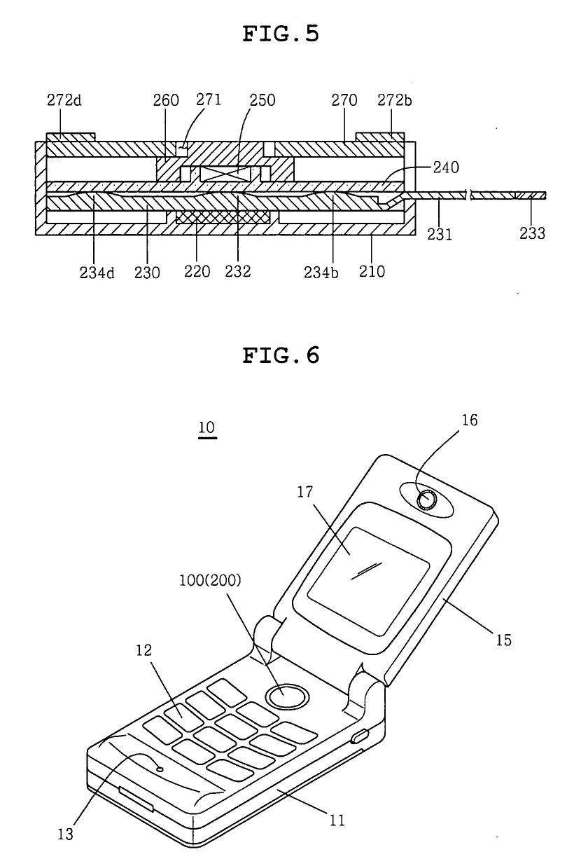

With reference to FIG. 4 and FIG. 5, a modular input device according to a second embodiment of the present invention will be described hereinbelow. FIG. 4 is an exploded perspective view and FIG. 5 is a cross-sectional view illustrating the modular input device according to the second embodiment of the present invention.

As shown in FIG. 4 and FIG. 5, the input device 200 according to the second embodiment of the present invention is implemented as a discrete modular unit, like the module input device 100 according to the first embodiment of the present invention, and comprises a housing 210, a sensor chip 220, a circuit board 230, an elastic body 240, a magnetic body 250, a manipulator 260 and a direction manipulator 270.

In the modular input device 200, most of the elements except the circuit board 230 and the direction manipulator 270 are substantially the same as the elements of the modular input device 100. Accordingly, a detailed description of like elements in the modular input device 100 of the first embodiment and the modular input device 200 of the second embodiment will be omitted.

Unlike the circuit board 130 of the first embodiment, the circuit board 230 of the second embodiment has an operation switch 232 installed at the center thereof and four direction switches 234a, 234b, 234c and 234d disposed around the operation switch 232 in four respective directions. The direction switches 234a, 234b, 234c and 234d operate independently of the operation switch 232. The direction switches 234a, 234b, 234c and 234d may serve as shift keys to move a cursor up, down, left and right in order to select an item from among a plurality of items when they are implemented in a mobile phone, or may serve as operation keys to adjust volume and change channels when they are adopted in a remote control. The circuit board 230 has a flexible substrate 231 that extends outside sufficiently far from an end portion of the circuit board 230, and the flexible substrate 231 has a contact terminal 233 at an end portion thereof so as to be connected to an external device.

The direction manipulator 270 is used to manipulate the direction switches 234a, 234b, 234c and 234d installed on the circuit board 230, and to protect all of the other elements from external impact, so the direction manipulator 270 is coupled to the inside of the housing 210 in a close contact manner. The direction manipulator 270 has an aperture 271 serving as a manipulation space at the center thereof so that the manipulating part 261 of the manipulator 260 is exposed through the aperture and can be displaced by a certain amount. Further, four direction keys 272a, 272b, 272c and 272d are installed along the edge of the circuit board 230 at respective positions corresponding to the four directions switches 234a, 234b, 234c and 234d.

On the surface of the four direction keys 272a, 272b, 272c and 272d, signs, such as “volume change” or “channel change”, representing the functions of respective keys, are displayed or marked so that a user can easily identify the functions of the keys.

FIG. 6 illustrates a mobile phone provided with the input device shown in FIG. 1 or FIG. 4.

The mobile phone 10 comprises a main body 11 including the input device 100 or 200 installed at an upper portion thereof, input buttons 12 installed at a lower portion thereof for allowing a user to input numerals or letters, and a microphone 13 installed beneath the input buttons 12 for allowing a user to input voice information, and a folder 15 including a speaker 16 for outputting voice information at an upper portion thereof and a display unit 17 installed at a lower portion thereof for displaying letters, still images or moving pictures. A user can easily and conveniently get a large volume of desired information using only the fingers.

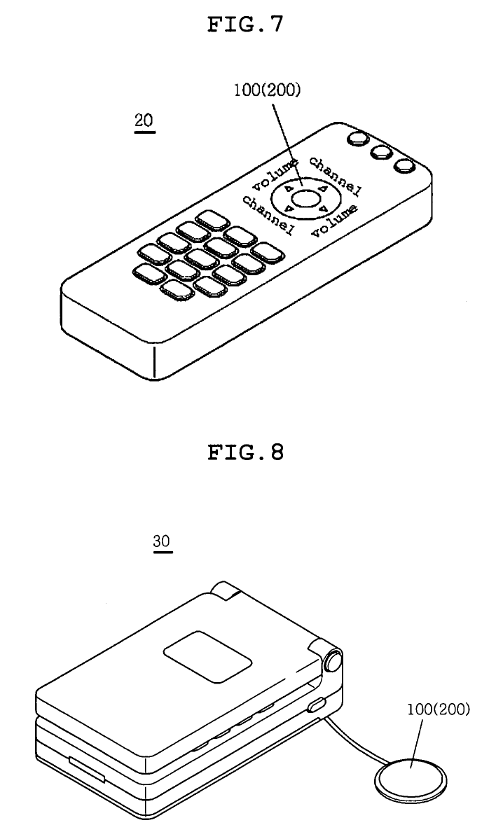

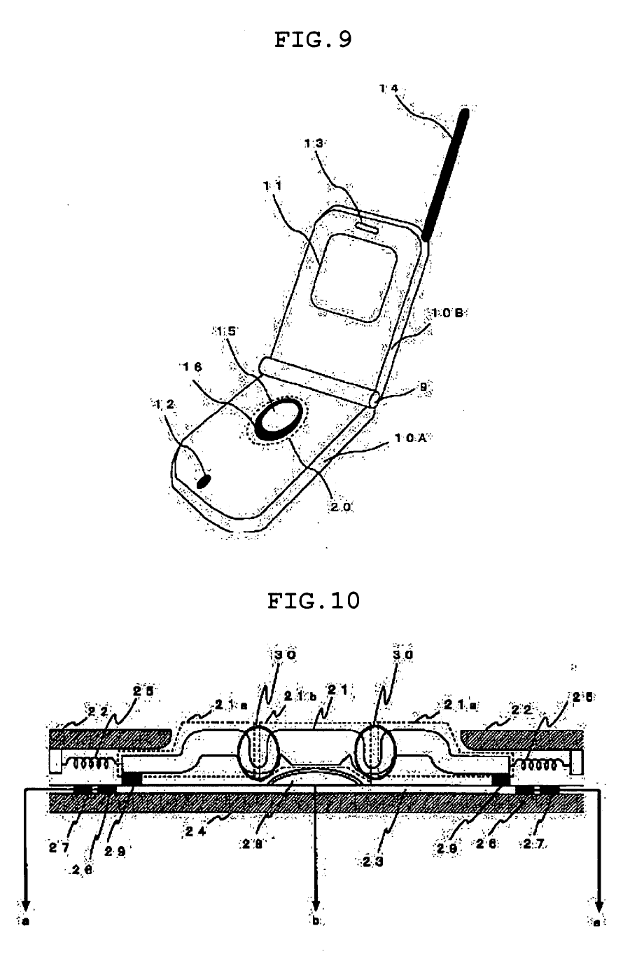

FIG. 7 illustrates a remote control in which the input device shown in FIG. 1 or FIG. 4 is installed.

The remote control 200 comprises the input device 100 or 200 installed at a center portion thereof. Direction keys are respectively marked with signs “channel ▴,” “channel ▾,” “ [symbol] volume,” and “volume [symbol] ,” and a central operation key is marked with a sign “settings.” A user can easily operate home appliances, such as a TV, which are usually controlled with a remote control, using the input device, and can also more easily perform work to get a large amount of information using the input device instead of a mouse in the case in which the user wants to search for desired information through an internet TV.

FIG. 8 illustrates a mobile phone in which the input device shown in FIG. 1 or FIG. 4 is installed as an external discrete unit.

In the case in which the input device 100 or 200 is installed to the mobile phone 30 as an external discrete unit, the input device 100 preferably has a small size. The input device 100 is designed to be hung from the mobile phone like an accessory. In this case, the input device 100 may have a connection means for connecting the input device 100 to a main circuit board embedded in the mobile phone.

Although the modular input device and the portable handset according to the present invention have been described with reference to embodiments of the present invention, those skilled in the art will appreciate that various modifications, additions and substitutions are possible, without departing from the scope and spirit of the invention as disclosed in the accompanying claims.

The modular input device according to the present invention has a variety of advantages.

First, since the input device according to the embodiments of the present invention is implemented in a modular form, the input device can be separately installed in a portable handset and can alone be easily and simply replaced when the input device fails or is damaged.

Second, since the input device is implemented as a discrete unit, separate from a portable handset, the input device and the portable handset can be manufactured in different production lines, so that the input device can be easily achieved through a variety of production methods.

Third, since the input device detects input signals (movement of a manipulating part) based on the intensity of magnetic force using hall sensors, fine signals (micro displacement of manipulating parts) can be precisely detected.

Fourth, since the portable handset equipped with the input device is easy to manipulate, a user can easily and simply manipulate the portable set by using just the fingers, without difficulty.

What is clamed is:

1. A modular input device, comprising:
a manipulator, movable in random directions;
a displacement detector for detecting displacement of the manipulator;
a signal output unit for outputting a signal detected by the displacement detector; and
a storage unit for storing the manipulator, the displacement detector and the signal output unit.

2. The modular input device according to claim 1, wherein the displacement detector detects displacement of the manipulator by detecting changes in intensity of magnetic force based on movement of the manipulator.

3. The modular input device according to claim 2, wherein the displacement detector includes a plurality of hall sensors responding to magnetic force.

4. A modular input device, comprising:
a manipulator, movable in random directions;
a sensor chip for detecting displacement of the manipulator,
a magnetic body that moves in association with the manipulator to inform the sensor chip of the displacement of the manipulator;
a circuit board having an operation switch at a position corresponding to the manipulator for outputting a signal detected by the sensor chip to an external device; and
a housing for enclosing the manipulator, the sensor chip, the magnetic body and the circuit board.

5. The modular input device according to claim 4, further comprising a cover for covering the housing and providing a manipulation space for the manipulator.

6. The modular input device according to claim 4, wherein the sensor chip has a plurality of hall sensors responding to magnetic force, and the hall sensors are arranged at regular intervals and have the same distance from an originally set position of the magnetic body.

7. The modular input device according to claim 4, wherein the circuit board has a flexible circuit part extending outside the circuit board, and the flexible circuit part has a contact terminal to be connected to an external device.

8. A portable handset provided with the modular input device according to claim 4, wherein the portable handset having the input device embedded therein in a manner such that the input device can be independently replaced.

9. A portable handset provided with the modular input device according to claim 4, herein the input device is externally installed so as to be connected to the handset.

10. A remote control provided with the modular input device according to claim 4, wherein the remote control has the input device embedded therein in a manner such that the input device can be independently replaced.

11. The modular input device according to claim 4, further comprising an elastic body for returning the displaced manipulator to an originally set position of the manipulator.

12. The modular input device according to claim 11, further comprising a cover for covering the housing and providing a manipulation space for the manipulator.

13. The modular input device according to claim 11, wherein the elastic body has a magnetic body mounting part for receiving the magnetic body thereon, and the manipulator has a groove for receiving the magnetic body mounting part with the magnetic body therein.

14. The modular input device according to claim 11, wherein the elastic body is made of rubber having high elasticity.

15. A portable handset provided with the modular input device according to claim 11, wherein the portable handset having the input device embedded therein in a manner such that the input device can be independently replaced.

16. A portable handset provided with the modular input device according to claim 11, wherein the input device is externally installed so as to be connected to the handset.

17. A remote control provided with the modular input device according to claim 11, wherein the remote control has the input device embedded therein in a manner such that the input device can be independently replaced.

18. The modular input device according to claim 4, further comprising a direction manipulator installed independently of the manipulator for manipulating directions and for proving a manipulation space for the manipulator.

19. A portable handset provided with the modular input device according to claim 18, the portable handset having the input device embedded therein in a manner such that the input device can be independently replaced.

20. A portable handset provided with the modular input device according to claim 18, wherein the input device is externally installed so as to be connected to the handset.

21. A remote control provided with the modular input device according to claim 18, wherein the remote control has the input device embedded therein in a manner such that the input device can be independently replaced.

22. The modular input device according to claim 18, further comprising an elastic body for returning the displaced manipulator to an originally set position thereof.

23. The modular input device according to claim 22, wherein the elastic body has a magnetic body mounting part for receiving the magnetic body thereon, and the manipulator has a groove for receiving the magnetic body mounting part with the magnetic body therein.

24. The modular input device according to claim 22, wherein the elastic body is made of rubber having high elasticity.

25. A portable handset provided with the modular input device according to claim 22, wherein the portable handset having the input device embedded therein in a manner such that the input device can be independently replaced.

26. A portable handset provided with the modular input device according to claim 22, wherein the input device is externally installed so as to be connected to the handset.

27. A remote control provided with the modular input device according to claim 22, wherein the remote control has the input device embedded therein in a manner such that the input device can be independently replaced.

28. The modular input device according to claim 18, wherein the direction manipulator has a plurality of direction keys, and the circuit board has a plurality of direction switches corresponding to the direction keys.

29. The modular input device according to claim 18, wherein the sensor chip has a plurality of hall sensors responding to magnetic force, and the hall sensors are arranged at regular intervals and have the same distance from an originally set position of the magnetic body.

30. The modular input device according to claim 18, wherein the circuit board has a flexible circuit part extending outside the circuit board, and the flexible circuit part has a contact terminal to be connected to an external device.
